(19) United States
(12) Patent Application Publication
(10) Pub. No.: US 2018/0118612 A1
(43) Pub. Date: May 3, 2018

(54) OLEOPHOBIC/HYDROPHOBIC NANO-ETCHED TOUCHSCREEN AND METHOD OF FORMING SAME

(71) Applicant: LENOVO ENTERPRISE SOLUTIONS (SINGAPORE) PTE. LTD., Sigapore (SG)

(72) Inventor: Kevin Perveiler, Wake Forest, NC (US)

(21) Appl. No.: 15/339,031

(22) Filed: Oct. 31, 2016

(51) Int. Cl. C03C 15/00; C03C 23/00

(52) U.S. Cl. CPC C03C 15/00; C03C 23/0025

(57) ABSTRACT

The present disclosure relates to glass structures, such as touchscreens, which are subjected to surface contaminants and glare and, more particularly, to providing nanostructures in a surface of such glass structures to render the surface oleophobic/hydrophobic. The structure is provided with an oleophobic/hydrophobic glass surface having nanostructures etched in the glass surface, wherein the size of the nanostructures prevents oil droplets and water droplets from fitting into the nano structures.

### TECHNICAL FIELD

The present disclosure relates to glass structures, such as touchscreens, which are subjected to surface contaminants and glare and, more particularly, to providing nanostructures in a surface of such glass structures to render the surface oleophobic/hydrophobic.

### BACKGROUND

Currently, glass surfaces, such as displays of touchscreen devices are subject to becoming dirty and smudged due to constant handling and being subjected to surface contaminants. Further, such glass surfaces suffer from glare when used in a bright environment.

For example, when a smart device (e.g., smart phones, tablets and touchscreen displays) is first purchased, the touchscreen is substantially smudge proof due to surface coatings which are applied during manufacture. These surface coatings have the benefit of rendering the touchscreen surface substantially oleophobic/hydrophobic since the surface coatings reject the adhesion of oils and moisture that can produce undesirable smearing of the screen surface. Replaceable protective films, typically formed of plastic or glass, can also be applied to the screen surface after purchase to protect the display against scratches, while also reducing glare.

Unfortunately, in a relatively short amount of time, typically after about six months of use, the chemical protective coating applied during or after manufacture of the touchscreen tends to wear off. Therefore, the glass surface is no longer oleophobic/hydrophobic, and the surface is much more susceptible to undesirable smudging. Also, the screen becomes stickier due to the smudging, so that the user's finger does not glide as well over the surface. The screen clarity can also be substantially degraded due to the greasy residue left by the user's fingers.

With regard to the after-market solutions, such as providing screen protection films, these are generally difficult to install, particularly due to dust and bubble formation. Further, such screen protection films generally wear out fairly quickly, and require routine replacement. In addition, such screen protection films reduce screen clarity and tactile response, thereby degrading device usability. Still further, aftermarket protective films generally have worse oleophobic/hydrophobic characteristics than the original screen, thereby resulting in increased screen smearing.

### SUMMARY

In an aspect of the disclosure, a glass structure is provided which includes an oleophobic/hydrophobic glass surface having nanostructures etched in the glass surface, wherein the size of the nanostructures prevents oil droplets and water droplets from fitting into the nanostructures.

In another aspect of the disclosure, a method is provided for rendering a glass surface oleophobic/hydrophobic by etching the glass surface with a femtosecond UV Excimer laser by controlling the wavelength, power level and pulse duration of the laser to micro-ablate the glass surface to vaporize portions of the glass surface to form nanostructures in the glass surface without substantially decreasing optical clarity of the glass surface, wherein the size of the nanostructures prevents oil droplets and water droplets from fitting into the nano structures.

In another aspect of the disclosure, a glass structure is provided having an oleophobic/hydrophobic glass surface having a nanostructure etched in the glass surface, wherein the nanostructure includes a plurality of recessed regions spaced apart from one another by non-recessed regions which form peaks between the recessed regions so that the glass surface will have a contact angle of 90° or greater for water droplets.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIG. 1 shows a laser etching structure for providing an oleophobic/hydrophobic surface to a glass structure such as a touchscreen in accordance with the present disclosure.

FIGS. 2(a)-2(c) show cross-sectional views of a glass structure having a glass surface with recessed regions and peaks in accordance with the present disclosure.

FIG. 3 shows an example of a water droplet impinging on an oleophobic/hydrophobic glass surface with etched nanostructures in accordance with the present disclosure.

FIG. 4 shows a flowchart of steps for treating a glass structure to create an oleophobic/hydrophobic glass surface with etched nanostructures in accordance with aspects of the present disclosure.

### DETAILED DESCRIPTION

The present disclosure relates to glass structures, such as touchscreens, which are subjected to surface contaminants and glare and, more particularly, to providing nanostructures in a surface of such glass structures to render the surface oleophobic/hydrophobic. More particularly, the present invention relates to oleophobic/hydrophobic (i.e., oil and water repellent) glass surfaces having nanostructures etched in a native screen material. In embodiments, the nanostructures are preferably etched with a femtosecond Excimer laser to subtract material to render the glass surface oleophobic/hydrophobic, instead of adding materials or coatings to obtain and oleophobic/hydrophobic surface. The oleophobic/hydrophobic characteristics of the resulting glass surface are essentially permanent for the life of the product, contrary to conventionally used surface coatings that wear away in a manner of months.

In addition to rendering the glass surface oleooleophobic/hydrophobic, the etched nanostructures also provide an anti-glare surface with lower friction, increased scratch resistance and improved strength relative to the unetched native screen surface. In addition, the glass structure with the laser etched nanostructures is more resistant to breakage.

The laser etched nanostructures are recessed regions preferably having a center-to-center spacing of about 200 nm. Non-recessed regions are formed as peaks between the plurality of recessed regions during the etching. These recessed regions can be formed, for example, as linear/grid patterns, patterns that create desired optical effects, staggered patterns such as a running bond or random patterns on the glass surface.

An advantage of the nanostructure of the present disclosure is that the recesses between the peaks are so small that very little can fit into these spaces to induce damage that would result as visible scratches, i.e., the glass surface is highly scratch resistant. Another advantage of the present disclosure is that, for example, the oleophobic/hydrophobic surface produced by the etching process provides improved display cleanliness since oil droplets and water droplets, even those small enough to only be seen as smudges, tend to simply roll off the glass surface. The etched surface also reduces glare, improves tactile response due to lowered surface friction, masks minor surface scratches and eliminates the need to apply aftermarket protective films. Further, since the etching process is part of the original fabrication of the glass structure, the resulting optical qualities are under the complete control of the manufacturer.

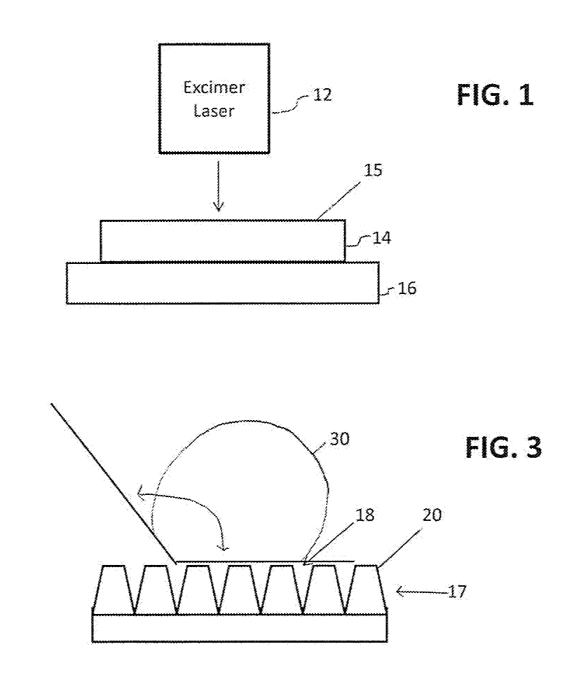

FIG. 1 shows an illustrative laser etching structure for providing an oleophobic/hydrophobic surface to a glass structure 14, such as a touchscreen, in accordance with the present disclosure. As shown in FIG. 1, an Excimer laser 12 is located above the glass structure 14, such as a touchscreen, which has a glass surface 15. The glass structure 14 is located on an X-Y translation table 16 which can be moved by one or more motors (not shown) to move the glass structure 14 so that the Excimer laser 12 can etch a desired pattern of nanostructures into the glass surface 15 to render the glass surface 15 oleophobic/hydrophobic. In alternative embodiments, the laser 12 can be moved or have its focus point changed while the glass surface remains stationary, or both the glass and the laser can move in coordination with one another.

In accordance with a preferred embodiment, the Excimer laser 12 can be implemented with a femtosecond deep-UV Excimer laser having a lower wavelength, higher power level and shorter pulse duration than a standard 193 nm wavelength Excimer laser conventionally used for visibly marking glass and jewels, such as diamonds. For example, the laser 12 can have a wavelength in a range between 126-175 nm, and a power level greater than 60 mW. In conjunction with these values of wavelength and power level, the pulse duration for the laser is tuned to attain a balance between contaminant rejection and optical clarity of the glass to etch nanostructures in the glass surface 15 which will render the glass surface 15 oleophobic/hydrophobic without adversely affecting the optical clarity of the glass surface 15. In particular, the wavelength, power level and pulse duration are set to avoid burning or blackening the glass surface 15, particularly in the case of manufacturing glass structures such as touchscreens which need to have high optical clarity.

In order to achieve the nanostructures in the glass surface 15 without adversely affecting optical clarity of the glass surface 15, the wavelength, power level and pulse duration are set to micro-ablate (i.e., vaporize) the glass surface 15. This ablative nanoetching will produce a transparent oleophobic/hydrophobic glass surface 15 with characteristics which are a permanent, integral part of the glass structure 14.

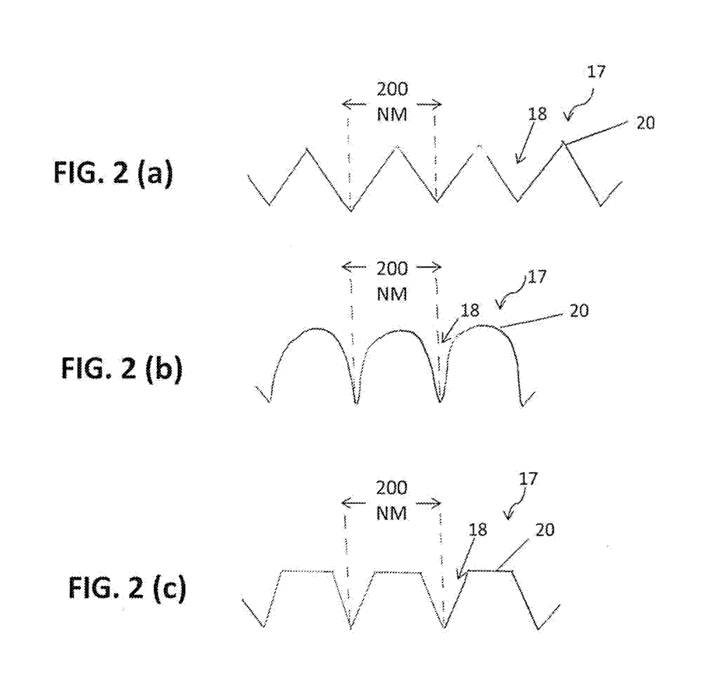

FIGS. 2(a), 2(b) and 2(c) show cross-sectional views of glass structures 14 having glass surfaces 15 with nanostructures 17 formed by recessed regions 18 and non-recessed peak regions 20. In accordance with preferred embodiments such as shown in FIGS. 2(a), 2(b) and 2(c), the recessed regions 18 have conical contours that replicate the oleophobic/hydrophobic structures occurring in nature. However, the recessed regions 18 can have other contours, including substantially perpendicular sidewalls with either flat or rounded bottom surfaces. Also, the recessed regions 18 can be arranged to form the nanostructures 17 as patterns in the glass surface 15. These patterns can include linear/grid patterns, patterns creating a desired optical effect, staggered patterns, such as a running bond, or patterns that are purely random.

As shown in FIGS. 2(a), 2(b) and 2(c), in accordance with embodiments the center-to-center spacing between adjacent recessed regions 18 is preferably about 200 nm to provide good oleophobic/hydrophobic characteristics. However, other spacings are possible, for example, between 100 nm and 500 nm.

As shown in FIG. 3, a surface is generally regarded as being hydrophobic if the contact angle between a water droplet 30 and the glass surface 15 exceeds 90°. A surface is regarded as being super-hydrophobic if the contact angle between a water droplet 30 on the surface exceeds 150°. In accordance with the present disclosure, providing the center-to-center spacing of 200 nm between adjacent recessed regions 18 of the nanostructures 17 provides a contact angle between a water droplet 30 and the glass surface 15 well in excess of 90°. Acceptable results can be expected with smaller or larger center-to-center spacings between adjacent recessed regions 18 of the nanostructures 17, for example, in the range of 100 nm-500 nm, especially if the main goal is to prevent smudging of the glass surface with oils as opposed to water.

As noted above, and as can be appreciated from FIG. 3, an oleophobic/hydrophobic surface provides recesses 18 of the nanostructures 17 so small that a water droplet 30 (or an oil droplet) will not be able to go into the recesses 18. As such, the depth of the recesses 18 is primarily set to allow the glass surface 15 to endure normal wear and tear, without wearing away the nanostructures 17. Typically a depth of at least 500 nm is used to ensure permanence for the recesses 18 of the nanostructures 17, since, for most glass compositions used, for example, for touchscreens, it would take years for the glass surface to wear down by 500 nm. However, shallower recesses 18 could still provide good oleophobic/hydrophobic characteristics for a substantial period of time, depending on the durability of the glass structure 14.

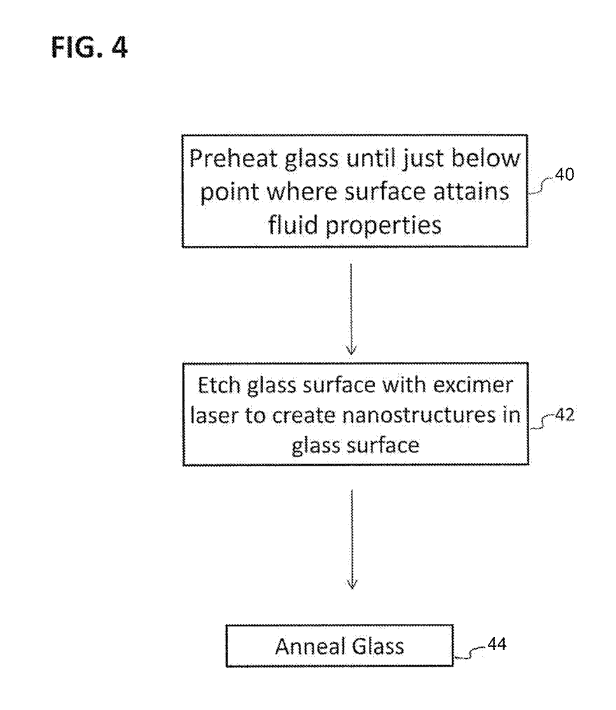

FIG. 4 shows a flowchart of steps to create an oleophobic/hydrophobic glass surface 15 with etched nanostructures 17 which can include additional steps before and after the etching operation to provide further improved results. For example, as shown in step 40 of FIG. 4, the glass structure 14 can be preheated prior to the laser application to reduce the temperature differential and lower the risk of surface fracturing from the etching treatment provided in step 42. In particular, the glass surface 15 can be preheated to a point just below where it attains fluid properties to reduce the risk of laser application, and also to reduce any undesirable burning effects that could render the glass surface 15 opaque. Regarding this, it is noted that such preheating can allow the glass surface 15 to flow slightly while it cools to an ambient temperature. Such flowing can reduce micro-fractures in the glass surface 15 caused by sudden heating with the laser, if such micro-fractures are deemed problematic, noting, however that some micro-fracturing could possibly enhance the oleophobic/hydrophobic characteristics of the glass so the degree of preheating could be adjusted accordingly. With regard to the preheating, it is noted that this can be performed in an oven, by performing the laser etching while the glass is still hot from being formed during its initial manufacture or by other means. Alternatively, the preheating can be performed using a 308 nm Excimer laser at a low power level to preheat the glass without causing premature annealing prior to the etching process.

As also shown in FIG. 4, it is generally desirable to perform step 44 to anneal the glass following the laser etching in step 42. The laser etching step 42 will rapidly heat the glass surface 15, and it is desirable to slowly cool the glass to induce annealing following this rapid heating. Such annealing can also be provided using a 308 nm Excimer laser for an annealing step 44 following the laser etching step 42. Regarding this, the same 308 nm Excimer laser can be used both for preheating and annealing, noting that the laser would be operated at a lower power level for the preheating operation.

Although femtosecond Excimer lasers are highly effective for etching nanostructures in glass in accordance with the present invention, as described above, other types of lasers could be used, provided they could etch appropriately small nanostructures 17 in a glass surface to achieve the desired oleophobic/hydrophobic characteristics without damaging the glass surface. For example, high-powered femtosecond laser systems, such as Ti:sapphire lasers used for etching metal surfaces, could be used. In order to avoid surface damage, though, preheating the glass surface prior to the laser application to a point just below where the glass attains fluid properties, as described above, reduces the risk of undesirable fracturing or burning of the glass surface by the laser.

Although laser etching provides the highest level of precision in forming the nanostructures in the glass surface, as discussed above, other etching processes could be used for creating such nanostructures, using, for example, chemical etching, abrasives or heat. It is noted that most such etching techniques for the purpose of creating oleophobic surfaces are directed to surface preparation to enhance the adhesion of oleophobic coatings. However, such non-laser etching techniques could be used as initial surface treatments prior to laser etching in accordance with the present disclosure in order to reduce or induce micro-fractures in the glass surface prior to the laser etching operation. It is noted that any tendency for the glass surface to be burned or otherwise rendered opaque by using lasers other than Excimer lasers, or other etching techniques, could be diminished by making a nanostructure random pattern rather than a uniform pattern.

Although the above description has been set forth with particular regard to touchscreens, it is noted that etching nanostructures using a femtosecond Excimer laser could be used for any glass or transparent surface, such as windows, windshields for automobiles, aircraft and boats, camera lenses and eyeglasses. In particular, the resulting benefits of providing an oleophobic/hydrophobic glass surface without damaging optical clarity presents numerous consumer and commercial benefits. It is also noted that the etching techniques described above create a surface that is lipophobic, that is, fat and organic solvent repellent, in addition to being oleophobic and hydrophobic.

In addition, a coating can be applied to the glass surface to augment the effects of the laser etching following the laser etching procedure. This provides the benefit that the laser etched surface can promote adhesion of the coating and also reduce the deterioration of the coating since the coating could be at least partially embedded into the etched surface recesses and, correspondingly, exposed to less physical wear. A combined technique of laser etching and coating also can simplify the screen surfacing process, allowing the use of lower precision laser etching.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A structure comprising:
oleophobic/hydrophobic glass surface having nanostructures etched in the glass surface,
wherein the size of the nanostructures prevents oil droplets and water droplets from fitting into the nanostructures.

2. The structure of claim 1, wherein the nanostructures comprise a plurality of recessed regions in the glass surface, wherein the recessed regions have a center-to-center spacing of about 200 nm.

3. The structure of claim 2, wherein the recessed regions each have conical contours, and wherein non-recessed regions are formed as peaks between the plurality of recessed regions.

4. The structure of claim 3, wherein the plurality of recessed regions form at least one of a linear/grid pattern, a pattern that creates a desired optical effect, a staggered pattern, or a random pattern on the glass surface.

5. The structure of claim 3, wherein the plurality of recessed regions form a random pattern on the glass surface.

6. The structure of claim 3, wherein the glass surface is a touchscreen.

7. A structure comprising:
an oleophobic/hydrophobic glass surface having a nanostructure etched in the glass surface,
wherein the nanostructure includes a plurality of recessed regions spaced apart from one another by non-recessed regions which form peaks between the recessed regions so that the glass surface will have a contact angle of 90° or greater for water droplets.

8. The structure of claim 7, wherein the recessed regions have a center-to-center spacing of about 200 nm.

9. The structure of claim 7, wherein the recessed regions each have conical contours, and wherein non-recessed regions are formed as peaks between the plurality of recessed regions during the etching.

10. The structure of claim 9, wherein the plurality of recessed regions form at least one of a linear/grid pattern, a pattern that creates a desired optical effect, a staggered pattern, or a random pattern on the glass surface.

11. The structure of claim 10, wherein the glass surface is a touchscreen, and wherein the glass structure further includes a coating on the glass surface formed over the plurality of recessed regions.

12. A method for rendering a glass surface oleophobic/hydrophobic, comprising:
etching the glass surface with a femtosecond UV Excimer laser by controlling wavelength, power level and pulse duration of the laser to micro-ablate portions of the glass surface to vaporize the portions of the glass surface to form nanostructures in the glass surface without substantially decreasing optical clarity of the glass surface,
wherein the size of the nanostructures are formed to prevent oil droplets and water droplets from fitting into the nano structures.

13. The method of claim 12, further comprising controlling the wavelength, power level and pulse duration of the laser to generate the nanostructures as a plurality of recessed regions in the glass surface, wherein the recessed regions have a center-to-center spacing of about 200 nm.

14. The method of claim 13, further comprising preheating the glass surface to a point just below where the glass surface attains fluid properties.

15. The method of claim 14, wherein the recessed regions each have conical contours, and wherein non-recessed regions are formed as peaks between the plurality of recessed regions during the etching.

16. The method of claim 15, wherein the glass surface is a touchscreen.

17. The method of claim 15, wherein the laser has a power level greater than 60 mW and a wavelength in a range between 126-175 nm.

18. The method of claim 17, further comprising annealing the glass surface after etching the glass surface with the laser.

19. The method of claim 18, wherein the at least one of the preheating and the annealing is performed by applying a 308 nm laser to the glass surface.

20. The method of claim 14, wherein the laser has a wavelength not greater than 175 nm and a power level greater than 60 mW.
